(19) United States
(12) Patent Application Publication
(10) Pub. No.: US 2015/0325149 A1
(43) Pub. Date: Nov. 12, 2015

(54) RESUSCITATION SIMULATOR WITH INSUFFLATION MEASUREMENT

(71) Applicant: 3B Scientific, Hamburg (DE)

(72) Inventor: Heiko Maleska-Kubick, Hamburg (DE)

(21) Appl. No.: 14/686,013

(22) Filed: Apr. 14, 2015

(30) Foreign Application Priority Data
May 8, 2014 (DE) 20 2014 102 156

(51) Int. Cl. G09B 23/28

(52) U.S. Cl. CPC G09B 23/288

(57) ABSTRACT

A resuscitation simulator with an insufflation tube for artificial respiration by a helper and a Venturi tube joined to the insufflation aperture by a respiratory air-conducting connection. The Venturi tube has a first tube section, with the first inner cross-sectional area, and a second tube section, with a second inner cross-sectional area, with the second inner cross-sectional area smaller than the first inner cross-sectional area. The first pressure measurement is made on the first section of the tube, and a second pressure measurement is provided on the second section of the tube. A pressure measuring device is provided which is connected to the first measurement position and the second measurement position, with which a differential pressure between the first measurement point and the second measurement point can be determined. The pressure measuring device generates a pressure measurement signal from the measured value. This signal is transmitted to a signal pre-processing circuit, which develops a volume flow via the Venturi tube derived the pressure measurement signal.

### CROSS-REFERENCE TO RELATED APPLICATIONS

The present application claims priority under 35 U.S.C. 119 to German utility model patent application 20 2014 102 156, filed on May 8, 2014, which is relied upon and incorporated herein in its entirety by reference.

### FIELD OF INVENTION

The invention concerns a respiratory simulator for reanimation attempts by a helper.

### BACKGROUND OF THE INVENTION

Resuscitation simulators in the form of human dummies for training a heart-lung resuscitation are well known. The resuscitation simulators are constructed as dummies in human form, with a mouth and a thoracic cage. For the simulation of a heart-lung resuscitation the thorax is compressed several time in succession and, after a certain number of compressions, the helper breathes into the mouth-form insufflation tube of the resuscitation simulator. The helper then repeats the resuscitation cycle.

The disadvantage of the known resuscitation simulators is that, in relation to insufflation, there is no sufficiently exact measurement of the volume flow of the insufflation air which the helper blows into the mouth of the resuscitation simulator.

### BRIEF SUMMARY OF THE INVENTION

In order to enable more promising reanimation attempts with the patient, however, it is helpful to perform insufflation with a defined volume flow, so that the non-breathing patient is given a sufficient amount of oxygen to minimise damage to organs due to an inadequate supply of oxygen.

In order that the helper can develop a proper feeling for the correct intensity of insufflation it is helpful to have feedback already during training and schooling, indicating whether the artificial respiration takes place with insufficient or excessive intensity. With the known resuscitation simulators, this is not possible to the extent required.

It is therefore the purpose of the present invention to make a resuscitation simulator available which mitigates the disadvantage described above.

This purpose is fulfilled by the resuscitation simulator described at the outset, with the attributes of Claim 1.

Accordingly, the invention foresees the availability of a resuscitation simulator with an insufflation tube for artificial respiration by a helper and a Venturi tube joined to the insufflation aperture by a respiratory air-conducting connection. The Venturi tube has a first tube section, with the first inner cross-sectional area, and a second tube section, with a second inner cross-sectional area, with the second inner cross-sectional area smaller than the first inner cross-sectional area. The first pressure measurement is made on the first section of the tube, and a second pressure measurement is provided on the second section of the tube. Next to this, a pressure measuring device is provided which is connected to the first measurement position and the second measurement position, with which a differential pressure between the first measurement point and the second measurement point can be determined. The pressure measuring device generates a pressure measurement signal from the measured value. This signal is transmitted to a signal pre-processing circuit, which develops a volume flow via the Venturi tube derived the pressure measurement signal.

With the connection of the resuscitation simulator to the Venturi tube as a component of a volume flow measuring instrument, followed by signal pre-processing, the invention furnishes information to the helper about the volume flow of the insufflation during reanimation training. The information about the magnitude of the volume flow serves as feedback for the helper and greatly improves the helper's schooling.

The resuscitation simulator ideally offers a human dummy with a mouth formed to an insufflation tube. The human dummy form of the resuscitation simulator of course has the advantage of simulating a real learning situation.

The insufflation tube is preferably connected by a rigid or flexible tube to the Venturi tube. The Venturi tube can be mounted at any arbitrary positions inside the human dummy or even outside the human dummy.

During operation of the resuscitation simulator the Venturi tube is preferentially mounted horizontally in order that no difference in the hydrostatic pressure occurs between the first and second measurement positions.

In a preferred design of the invention the second inner cross-sectional is less than 0.25 times, preferably less than 0.2 times and in a particularly preferred design less than 0.15 times, the size of the first inner cross-sectional area. A large difference of the inner cross-sectional areas results in a particularly exact measurement.

In a preferred design of the invention the position of the first pressure measurement has a measurement tap emerging from the first tube section joined to the inner space of the tube section by a respiratory air-conducting connection. The second pressure measurement position has a second measurement tap which likewise has a respiratory air-conducting connection to the inner space of the second tube section. The two measurement taps can be simultaneously connected to a differential pressure measuring device, which in a preferred design of the invention allows the determination of the differential pressure between the first pressure measurement position and the second pressure measurement position.

However, connecting an absolute pressure measuring device to the first measurement tap and connecting a second absolute pressure measuring device to the second measurement tap is also conceivable. A difference measurement signal can then be generated by pre-processing the absolute pressure measurement signal sensors for the first absolute pressure and the second absolute pressure and utilising this signal for further evaluation. Furthermore, each of the absolute pressure measuring devices also furnishes a further measurement signal with information about the pressure of the insufflated respiratory air and which can be separately evaluated.

The resuscitation simulator ideally exhibits a signal pre-processing circuit downstream from the resuscitation simulator. A signal output of the differential pressure measuring device supplies a differential pressure signal ideally connected to an amplifier which amplifies the differential pressure signal and sends this to an analog-digital converter and, from there, to a microprocessor. The microprocessor can further process the differential pressure measurement signal, preferably generating a volume flow measurement signal from the differential pressure measurement signal. The volume flow measurement signal can preferably be read out in graphical form or, following the evaluation of the volume flow measurement signal, as a visual or an acoustical warning signal when the value lies below a lower volume flow limit or the value exceeds an upper volume flow limit.

### BRIEF DESCRIPTION OF THE SEVERAL VIEWS OF THE DRAWINGS

The invention is described with the help of a design example, in four figures.

FIG. 1 shows a schematic sectional view of the resuscitation simulator in accordance with the invention described, with an insufflation measuring device based on the Venturi principle.

FIG. 2 shows a detailed view of the Venturi tube in FIG. 1.

FIG. 3 shows a block diagram for the evaluation of a differential pressure measurement signal deriving from the Venturi tube.

FIG. 4 schematically shows the graphical relationship between the volume flow and the magnitude of the differential pressure measurement signal.

### DETAILED DESCRIPTION OF THE INVENTION

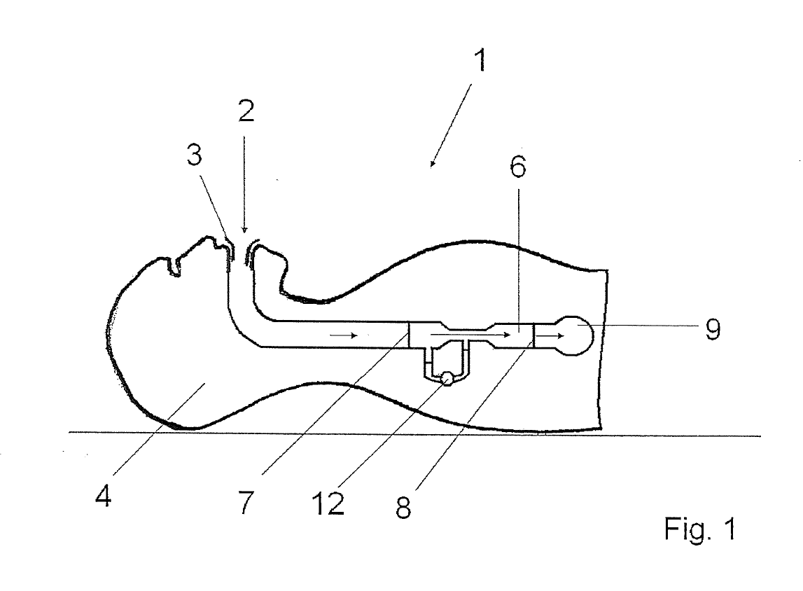

FIG. 1 shows a sectional view of the thorax of a resuscitation simulator 1 in the form of a human dummy.

For the reanimation of a patient, the helper must perform a sequence of cardiac massages and insufflation phases. The helper performs the cardiac massages by compressing the thorax of the patient and the artificial respiration phases by blowing his own breath into the mouth and/or nose of the patient.

In order to enable a high probability of successful reanimation with the sequence of cardiac massages and insufflation phases by the helper, during insufflation the helper must blow a defined amount of air per unit time into the lungs of the non-breathing patient. In accordance with the reanimation guidelines of the European Resuscitation Council (ERC), which formulates the medical requirements for insufflation during heart-lung resuscitation, a typical value of 600 ml per second is specified as the target value for adults.

The resuscitation simulator 1 illustrated in FIG. 1 serves for the training and exercising of the proper artificial respiration of the non-breathing patient by the helper. The resuscitation simulator 1 comprises a thorax with a head and a mouth formed to an insufflation tube 2. To attempt reanimation, the helper presses his lips as, well as possible, air-tight onto the insufflation tube 2 in order to then blow respiratory air with his own pulmonary pressure into the resuscitation simulator 1.

For hygienic reasons the insufflation tube 2 has a replaceable mouthpiece 3, which allows successive training for several helpers after replacing.

The insufflation tube 2 is joined via a curved and flexible respiratory air-conducting tube 4 to a Venturi tube 6. The Venturi tube 6 has a first connection 7 for connecting to the hose 4 and a second connection 8, which is joined by a respiratory air-conducting connection to a flexible bag 9. The connections can be common plug-in connections.

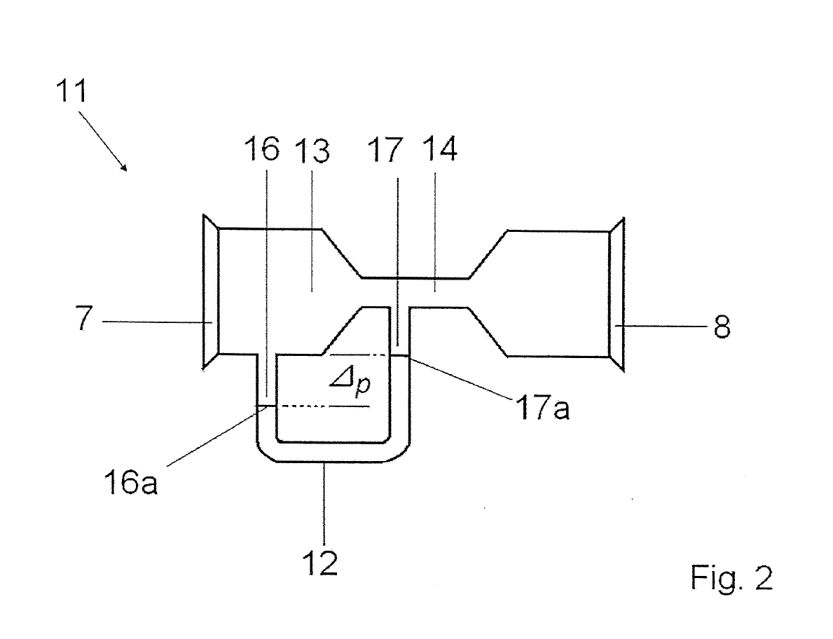

The Venturi tube 6 is part of a volume flow measuring device 11, as illustrated schematically in FIG. 2. The volume flow measurement device 11 has a differential pressure sensor 12 next to the Venturi tube 6, shown here as a u-tube.

The Venturi tube 6 has a first inner cross-sectional area in the first section of the tube 13, close to the first connection 7, with a first inner cross-sectional area A₁ followed in the direction of flow by a second section of the tube, with a second inner cross-sectional area A₂ which is smaller than the first inner cross-sectional area A₁.

The Venturi tube 6 shown in FIG. 2 has a circular inner cross-sectional area in both the first tube section 13 and the second tube section 14. The diameter of the inner cross-sectional area of the first tube section 13 is 10 mm and the diameter of the inner cross-sectional area of the second tube is 4 mm. The two sections of tube 13, 14 are joined by a conical respiratory air-conducting connection. The inner cross-sectional areas A₁, A₂ of the first and second tube sections 13, 14 are constant over the longitudinal direction of the respective insufflated air direction.

The first section of tube 13 has a first measurement tap 16a at the first pressure measurement position 16 for the differential pressure sensor 12, and the second section of tube 14 has a second pressure measurement position with a second measurement tap 17a for the differential pressure sensor 12.

FIG. 2 illustrates the differential pressure sensor 12 in very simple schematic representation by a u-tube filled with fluid, in which the Venturi tube sets an asymmetric level from which the pressure difference can be calculated during operation.

Under the assumption of stationary flow, the pressure behaviour of the air which the helper blows into the insufflation tube 2 and, from there, via the tube 4 into the Venturi tube 6, is described to a good approximation by the Bernoulli equation.

$${p}_{1} + ρ {gh}_{1} + \frac{ρ}{2} {v}_{1}^{2} = {p}_{2} + ρ {gh}_{2} + \frac{ρ}{2} {v}_{2}^{2} = constant$$

p₁ describes the static pressure at measurement position 16,

ρgh₁ describes the hydrostatic pressure at measurement position 16 and

$$\frac{ρ}{2} {v}_{1}^{2}$$

describes the dynamic pressure at measurement position 16.

The same applies for the variables with index “2” determined at measurement position 17.

As the first and second measurement positions 16, 17 are at the same height above the ideal ground level, the Venturi tube 6 is aligned horizontally relative to the ground level and the hydrostatic pressure at measurement position 16 is identical with the hydrostatic pressure at measurement position 17. It then follows that

$${p}_{1} + \frac{ρ}{2} {v}_{1}^{2} = {p}_{2} + \frac{ρ}{2} {v}_{2}^{2} \\ ⇔ {p}_{1} - {p}_{2} = Δ p = \frac{ρ}{2} \{ {v}_{2}^{2} - {v}_{1}^{2} \}$$

As the continuity equation

A₁ν₁=A₂ν₂

applies along the Venturi tube 6 solving for ν₂, setting into the equation above and the solving for ν₁² gives

$${v}_{1} = \sqrt{\frac{2 Δ p}{ρ [ {\{ \frac{{A}_{1}}{{A}_{2}} \}}^{2} - 1 ]}}$$

The volume flow

\dot{V}₁=\dot{V}₂=A₁ν₁=A₂ν₂

is therefore calculated to be

$${\dot{V}}_{1} = {A}_{1} \sqrt{\frac{2 Δ p}{ρ [ {\{ \frac{{A}_{1}}{{A}_{2}} \}}^{2} - 1 ]}}$$

The first inner cross-sectional area A₁ of the first tube section 13 and the second inner cross-sectional area A₂ of the second tube 14 are constructionally specified, and the differential pressure Δp is determined by the differential pressure measuring device 12 as in FIG. 2.

The helper should be trained so that the volume flow \dot{V}₁ which he produces gives a value of about \dot{V}=600 ml/sec in the Venturi tube 6.

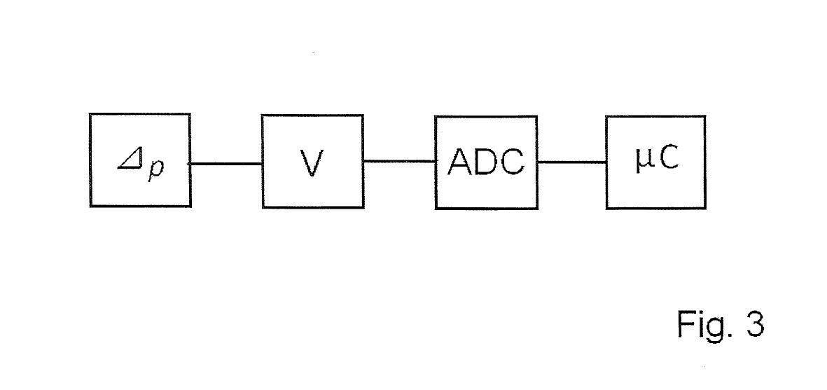

FIG. 3 shows the differential pressure measuring device 12 as an electronic measuring instrument, which converts the measured differential pressure to a differential pressure measurement signal. The differential pressure measurement signal is amplified in an amplifier circuit V and sent to an analog-digital converter. The ADC converts the analog measurement signal to a digital signal and sends this signal to a microprocessor μC for further processing.

In the microprocessor μC the measured data can be evaluated and, as required, displayed in graphical form. The data can control visual or acoustical warning signal devices as required when the value lies below a lower volume flow limit or the value exceeds an upper volume flow limit.

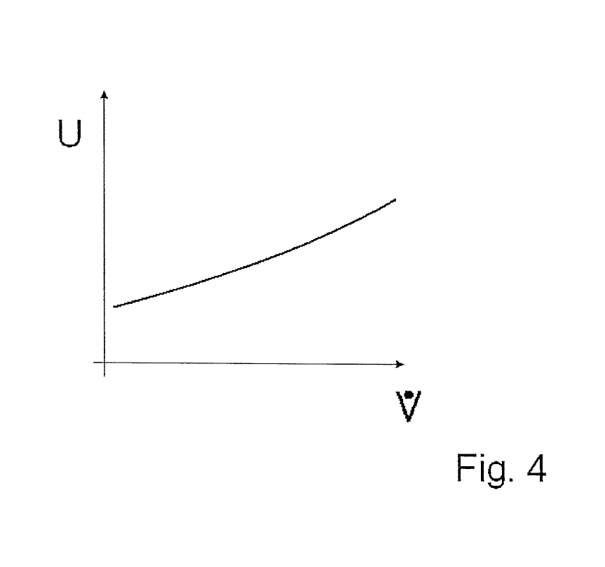

FIG. 4 schematically shows the functional relationship between the volume flow \dot{V}₁ and the magnitude of the amplified analog signal at the output of the amplifier circuit V as a graphical display. The resuscitation simulator 1 for the invention described therefore enables a detailed evaluation of the helper's reanimation attempts as regards the display of the volume flow \dot{V}₁ at which the helper has attempted reanimation. When the value of the volume flow \dot{V}₁ required for resuscitation lies, for example, below a visual or acoustical warning signal can be given. The data can also be acquired first and discussed with the helper.

Although the invention herein has been described with reference to particular embodiments, it is to be understood that these embodiments are merely illustrative of the principals and applications of the present invention. Accordingly, while the invention has been described with reference to the structures and processes disclosed, it is not confined to the details set forth, but is intended to cover such modifications or changes as may fall within the scope of the following claims.

### FIGURE REFERENCES

1 Resuscitation simulator
2 Insufflation tube
3 Mouthpiece insert
4 Tube
6 Venturi tube
7 First connection
8 Second connection
9 Flexible bag
11 Volume flow measuring device
12 Differential pressure measuring device
13 First tube section
14 Second tube section
16 First pressure measurement position
16a First measurement tap
17 Second measurement position
17a Second measurement tap
A₁ First inner cross-sectional area of the Venturi tube
A₂ Second inner cross-sectional area of the Venturi tube
V Amplifier circuit
μC Microprocessor
Δp Differential pressure
\dot{V}₁ Volume flow
\dot{V}₂ Volume flow

What is claimed is:

1. A resuscitation simulator for reanimation attempts by a helper comprising:
an insufflation tube (2) for blowing in the helper's respiratory air,
a Venturi tube (6) joined to the insufflation tube (2) by a respiratory air-conducting connection, with the first section of tube (13) having an inner cross-sectional area (A₁) and a second section of tube (14) with an inner cross-sectional area (A₂) which is smaller than the first inner cross-sectional area (A₁),
with a first pressure measurement position (16) in the first tube section (13) and
a second pressure measurement position (17) in the second (14); and
a pressure measuring device (12), with which the differential pressure between the first pressure measurement position (16) and the second pressure measurement position (17) is determined and which generates a pressure measurement signal, a signal pre-processing circuit, with which the pressure measurement signal derived from the Venturi tube (6) enables the calculation of the volume flow (\dot{V}₁ \dot{V}₂).

2. A resuscitation simulator as described in claim 1, characterised by a human dummy with a mouth formed to an installation tube (2).

3. A resuscitation simulator as described in claim 1, wherein the insufflation tube (2) is connected by a hose (4) to the Venturi tube (6).

4. A resuscitation simulator as described in claim 1, wherein the Venturi tube (6) is aligned horizontally during operation.

5. A resuscitation simulator as described in claim 1, wherein the second cross-sectional area (A₂) is less than 0.25 times, preferably less than 0.20 times and particularly preferred less than 0.15 times, the size of the first cross-sectional area (A₁).

6. A resuscitation simulator as described in claim 1, wherein the first pressure measurement position (16) includes a measurement tap (16a) emerging from the first tube section (16) joined with the inner space of the first tube section (13) by a respiratory air-conducting connection and the second pressure measurement position (17) having a second measurement tap (17a) which likewise has a respiratory air-conducting connection to the inner space of the second tube section (14).

7. A resuscitation simulator as described in claim 1, wherein the pressure measuring device includes a first absolute pressure measuring device at the first pressure measurement position (16) and a second absolute pressure measuring device at the second pressure measurement position (17).

8. A resuscitation simulator as described in claim 7, further comprising a differential pressure circuit with a first connection to the first absolute pressure measuring device and a second connection to the second absolute pressure measuring device for the determination of the differential pressure (Δp) from the first absolute pressure measurements and the second absolute pressure measurements.

9. A resuscitation simulator as described in claim 1, wherein the differential pressure measuring device is connected to an amplifier circuit (V).

10. A resuscitation simulator as described in claim 9, wherein the amplifier circuit output (V) is connected to an analog-digital converter (ADC), with output to a microprocessor (μC) for the processing of the measured values.

11. A resuscitation simulator as described in claim 10, wherein the microprocessor (μC) includes a signalling device which issues a warning signal when the value lies below a pre-set lower volume flow limit or the value exceeds a pre-set upper volume flow limit.
